(19) United States
(12) Patent Application Publication
(10) Pub. No.: US 2021/0057161 A1
(43) Pub. Date: Feb. 25, 2021

(54) MULTILAYER CERAMIC ELECTRONIC COMPONENT

(71) Applicant: Murata Manufacturing Co., Ltd., Nagaokakyo-shi (JP)

(72) Inventors: Kota ZENZAI, Nagaokakyo-shi (JP); Yosuke TERASHITA, Nagaokakyo-shi (JP)

(21) Appl. No.: 16/897,320

(22) Filed: Jun. 10, 2020

(30) Foreign Application Priority Data
Aug. 20, 2019 (JP) 2019-150135

(51) Int. Cl. H01G 4/30; H01G 4/248; H01G 4/012; H01G 4/12

(52) U.S. Cl. CPC H01G 4/30; H01G 4/12; H01G 4/012; H01G 4/248

(57) ABSTRACT

A multilayer ceramic electronic component includes a ceramic body and outer electrodes on two end surfaces of the ceramic body. Each of the outer electrodes includes a base electrode layer that is on the ceramic body and includes a sintered metal and glass, and a conductive resin layer that is on the base electrode layer and includes a metal filler and a resin. When a maximum thickness of the conductive resin layers that respectively lie on end surfaces of the ceramic body is denoted as T1 and when a maximum thickness of conductive resin layers adjacent to a first main surface and second main surface of the ceramic body or a first side surface or a second side surface of the ceramic body is denoted as T2, T1/T2 is about 2.4 or more.

### CROSS REFERENCE TO RELATED APPLICATIONS

This application claims the benefit of priority to Japanese Patent Application No. 2019-150135 filed on Aug. 20, 2019. The entire contents of this application are hereby incorporated herein by reference.

### BACKGROUND OF THE INVENTION

### 1. Field of the Invention

The present invention relates to multilayer ceramic electronic components and, specifically, to a multilayer ceramic electronic component, for example, a multilayer ceramic capacitor, a multilayer ceramic inductor, a multilayer ceramic thermistor, or a multilayer ceramic piezoelectric component, that includes a ceramic body including inner electrodes imbedded therein and outer electrodes provided on end surfaces of the ceramic body and electrically connected to the inner electrodes.

### 2. Description of the Related Art

One example of a known multilayer ceramic electronic component is disclosed, for example, in Japanese Unexamined Patent Application Publication No. 2015-046644. In this multilayer ceramic electronic component, a ceramic body burying inner electrodes have two end surfaces in which the inner electrodes are exposed, and an outer electrode that includes a base electrode layer containing a metal as a main component, a conductive resin layer containing metal particles formed on a surface of the base electrode layer, and a plating layer formed a surface of the conductive resin layer is disposed on each of the two end surfaces. In this multilayer ceramic electronic component, since the conductive resin layer is interposed between the base electrode layer and the plating layer, cracks rarely occur in the ceramic body under the temperature cycles during the use, and thus, when this multilayer ceramic electronic component is mounted on a substrate, the component exhibits improved strength against deflection of the substrate.

However, since the conductive resin layer of the known multilayer ceramic electronic component described above contains metal particles and a synthetic resin, the equivalent series resistance tends to be high.

In addition, since the conductive resin layer has a different thermal behavior than the base electrode layer (or the ceramic body), the adhesive force of the conductive resin layer is decreased, and the conductive resin layer easily detaches from the base electrode layer (or the ceramic body).

### SUMMARY OF THE INVENTION

Preferred embodiments of the present invention provide multilayer ceramic electronic components in each of which the equivalent series resistance of the outer electrodes is significantly reduced to a low level and the conductive resin layer provides a high adhesive force.

According to a preferred embodiment of the present invention, a multilayer ceramic electronic component includes a ceramic body including ceramic layers that are stacked, and a first inner electrode and a second inner electrode that are stacked, the ceramic body including a first main surface and a second main surface that face each other in a stacking direction, a first side surface and a second side surface that face each other in a width direction orthogonal or substantially orthogonal to the stacking direction, and a first end surface and a second end surface that face each other in a length direction orthogonal or substantially orthogonal to the stacking direction and the width direction; a first outer electrode provided on the first end surface of the ceramic body and electrically connected to the first inner electrode layer, the first outer electrode extending from the first end surface and cover a portion of the first main surface, a portion of the second main surface, a portion of the first side surface, and a portion of the second side surface; and a second outer electrode provided on the second end surface of the ceramic body and electrically connected to the second inner electrode layer, the second outer electrode extending from the second end surface and cover a portion of the first main surface, a portion of the second main surface, a portion of the first side surface, and a portion of the second side surface. The first outer electrode includes a first conductive resin layer including a metal filler dispersed in a resin. The second outer electrode includes a second conductive resin layer including a metal filler dispersed in a resin. When a maximum thickness of the first conductive resin layer in the first outer electrode on the first end surface of the ceramic body is denoted as T1 and a maximum thickness of the first conductive resin layer adjacent to the first and second main surfaces of the ceramic body or the first and second side surfaces of the ceramic body is denoted as T2, T1/T2 is about 2.4 or more. When a maximum thickness of the second conductive resin layer in the second outer electrode on the second end surface of the ceramic body is denoted as T1 and a maximum thickness of the second conductive resin layer adjacent to the first and second main surfaces of the ceramic body or the first and second side surfaces of the ceramic body is denoted as T2, T1/T2 is about 2.4 or more.

In this multilayer ceramic electronic component, increasing the thickness T1 increases the contraction stress acting toward the two end surfaces of the ceramic body and increases the contact area between the particles of the metal filler included in the first conductive resin layers, resulting in a lower equivalent series resistance (ESR). However, when the thickness T2 is excessively large, the contraction stress in the length direction of the ceramic body becomes excessively strong. Thus, separation easily occurs at the contact portion (adjacent to or in a vicinity of an e dimension end portion) between the conductive resin layers and the ceramic body.

Thus, in the multilayer ceramic electronic components according to preferred embodiments of the present invention, the relevant portions of the conductive resin layers are specified so that T1/T2 satisfies the condition of about 2.4 or more. Thus, the ESR of the outer electrodes is able to be significantly reduced to a low level, and the adhesive force of the conductive resin layers is able to be significantly increased.

According to preferred embodiments of the present invention, even when conductive resin layers are included in outer electrodes, the equivalent series resistance of the outer electrodes is able to be significantly reduced to a low level, and multilayer ceramic electronic components that each include conductive resin layers having a high adhesive force are able to be provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of the appearance of one example of the multilayer ceramic electronic component according to a preferred embodiment of the present invention.

FIG. 2 is a cross-sectional view of the multilayer ceramic electronic component shown in FIG. 1 taken along line II-II.

FIG. 3 is a cross-sectional view of the multilayer ceramic electronic component shown in FIG. 1 taken along line III-III.

FIG. 4 is an enlarged cross-sectional view of the cross-sectional view of FIG. 2.

FIGS. 5A and 5B are views each showing the state in which a conductive resin paste is applied to a ceramic multilayer body by pulling up the ceramic multilayer body from a paste vessel during formation of the conductive resin layer, FIG. 5A shows the state in which the ceramic multilayer body is pulled up at a relatively high speed, and FIG. 5B shows the state in which the ceramic multilayer body is pulled up at a relatively low speed.

FIG. 6 is a graph showing the relationship between T1/T2 and ESR.

### DETAILED DESCRIPTION OF THE PREFERRED EMBODIMENTS

### 1. Multilayer Ceramic Electronic Component

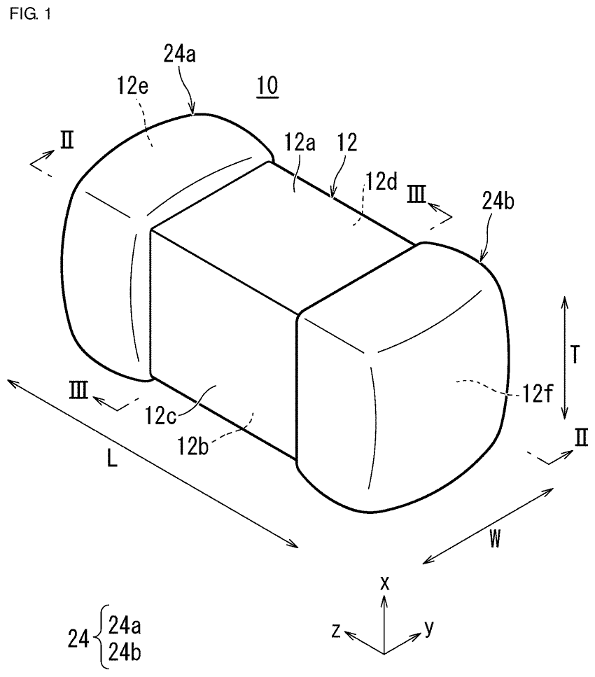

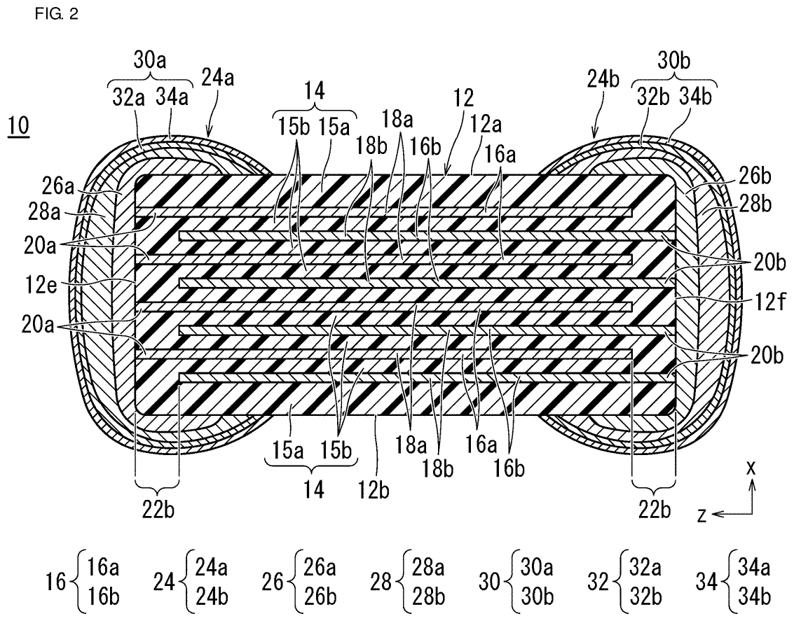

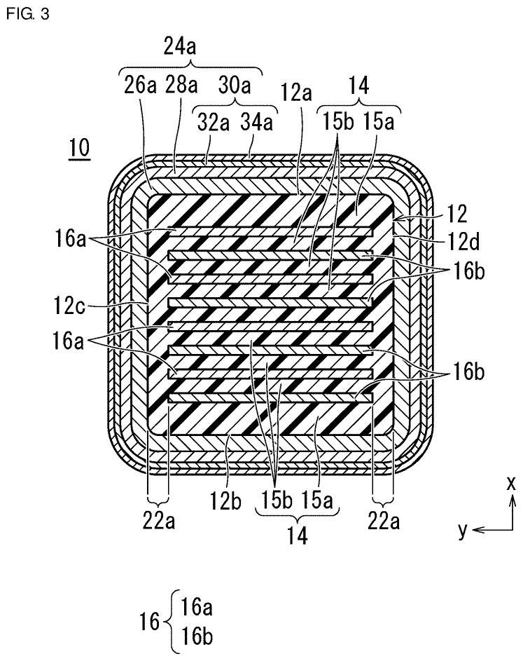

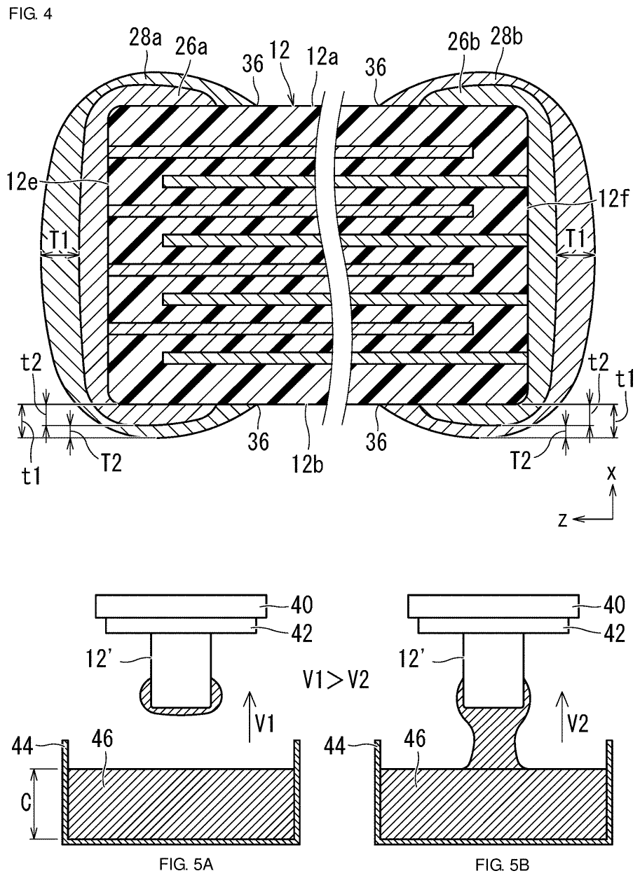

A multilayer ceramic electronic component according to a preferred embodiment of the present invention will now be described. FIG. 1 is a perspective view of the appearance of one example of the multilayer ceramic electronic component according to a preferred embodiment of the present invention. FIG. 2 is a cross-sectional view of the multilayer ceramic electronic component shown in FIG. 1 taken along line II-II. FIG. 3 is a cross-sectional view of the multilayer ceramic electronic component shown in FIG. 1 taken along line FIG. 4 is an enlarged cross-sectional view of the cross-sectional view of FIG. 2.

In the description below, a multilayer ceramic capacitor is used as an example of the multilayer ceramic electronic component.

A multilayer ceramic capacitor 10 includes a rectangular parallelepiped or substantially rectangular parallelepiped ceramic body 12 and two outer electrodes 24.

### (1) Ceramic Body

The ceramic body 12 includes a stack including multiple ceramic layers 14 and multiple inner electrode layers 16. The ceramic body 12 includes a first main surface 12a and a second main surface 12b that face each other in the stacking direction x; a first side surface 12c and a second side surface 12d that face each other in a width direction y orthogonal or substantially orthogonal to the stacking direction x (the direction connecting the first main surface 12a and the second main surface 12b); and a first end surface 12e and a second end surface 12f that face each other in a length direction z orthogonal or substantially orthogonal to the stacking direction x and the width direction y (the direction connecting the first side surface c and the second side surface 12d). The size of the ceramic body 12 is not particularly limited. However, the dimension of the ceramic body 12 in the length direction z is not necessarily larger than that in the width direction y.

The dimension of the multilayer ceramic capacitor 10, which includes the ceramic body 12 and the two outer electrodes 24, in the length direction z is denoted the L dimension. The dimension of the multilayer ceramic capacitor 10 in the stacking direction x is denoted as the T dimension. The dimension of the multilayer ceramic capacitor 10 in the width direction y is denoted as the W dimension.

Corner portions and ridge portions of the ceramic body 12 are preferably rounded, for example. Here, a corner portion refers to a portion where three adjacent surfaces of the ceramic body 12 meet, and a ridge portion refers to a portion where two adjacent surfaces of the ceramic body 12 meet. Recesses, protrusions, and other features may be provided in some or all portions of the first main surface 12a, the second main surface 12b, the first side surface 12c, the second side surface 12d, the first end surface 12e, and the second end surface 12f.

### (a) Ceramic Layers

The ceramic body 12 includes outer layer portions 15a each defined by multiple ceramic layers 14, and an inner layer portion 15b defined by one or more ceramic layers 14 and multiple inner electrode layers 16 provided on the ceramic layers 14. The outer layer portions 15a are combined bodies of the ceramic layers 14 that are adjacent to the first main surface 12a and the second main surface 12b of the ceramic body 12. In particular, the outer layer portions 15a are, respectively, a combined body that includes ceramic layers 14 between the first main surface 12a of the ceramic body 12 and the inner electrode layer 16 closest to the first main surface 12a, and a combined body that includes ceramic layers 14 between the second main surface 12b of the ceramic body 12 and the inner electrode layer 16 closest to the second main surface 12b. The region sandwiched between the two outer layer portions 15a is the inner layer portion 15b. The thickness of each of the outer layer portions 15a is preferably about 15 μm or more and about 400 μm or less, for example.

The number of ceramic layers 14 including those in the outer layers is preferably about 10 or more and about 2000 or less, for example.

The ceramic layers 14 may be made, for example, of a dielectric material. Examples of the dielectric material include dielectric ceramics that are mainly including BaTiO₃, CaTiO₃, SrTiO₃, or CaZrO₃. When the dielectric materials are included as a main component, a sub component, the content of which is lower than the main component, for example, a Mn compound, an Fe compound, a Cr compound, a Co compound, or a Ni compound, may be added depending on the predetermined characteristics of the ceramic body 12.

The thickness of the ceramic layer 14 after firing is preferably about 0.5 μm or more and about 20 μm or less, for example.

### (b) Inner Electrode Layers

The inner electrode layers 16 in the ceramic body 12 include, for example, first inner electrode layers 16a and second inner electrode layers 16b having a rectangular or substantially rectangular shape. The first inner electrode layers 16a and the second inner electrode layers 16b are alternately stacked at equal or substantially equal intervals in the stacking direction x of the ceramic body 12 with the ceramic layers 14 therebetween, and buried in the ceramic body 12.

A first inner electrode layer 16a includes a first opposing electrode portion 18a opposing the second inner electrode layer 16b, and a first extended electrode portion 20a adjacent to one end of the first inner electrode layer 16a. The first extended electrode portion 20a spans from the first opposing electrode portion 18a to the first end surface 12e of the ceramic body 12. The first extended electrode portion 20a includes an end portion that is extended to and exposed in the first end surface 12e.

A second inner electrode layer 16b includes a second opposing electrode portion 18b opposing the first inner electrode layer 16a, and a second extended electrode portion 20b adjacent to one end of the second inner electrode layer 16b. The second extended electrode portion 20b spans from the second opposing electrode portion 18b to the second end surface 12f of the ceramic body 12. The second extended electrode portion 20b has an end portion that is extended to and exposed in the second end surface 12f.

The ceramic body 12 includes side portions (hereinafter referred to as “W gaps”) 22a provided between the first side surface 12c and first ends of the first opposing electrode portions 18a and the second opposing electrode portions 18b in the width direction y, and between the second side surface 12d and second ends of the first opposing electrode portions 18a and the second opposing electrode portions 18b in the width direction y. In addition, the ceramic body 12 includes end portions (hereinafter referred to as “L gaps”) 22b provided between the second end surface 12f and end portions of the first inner electrode layers 16a on the side opposite of the first extended electrode portions 20a, and between the first end surface 12e and end portions of the second inner electrode layers 16b opposite of the second extended electrodes 20b.

The inner electrode layers 16 may be made of a conductive material including at least one material selected from Ni, Cu, Ag, Pd, Au, Ag—Pd alloys, etc., for example. The inner electrode layers 16 may further include dielectric particles having the same or similar composition system as that of the ceramic included in the ceramic layers 14.

The thickness of each inner electrode layer 16 is preferably about 0.2 μm or more and about 2.0 μm or less, for example. The number of inner electrode layers 16 is preferably about 15 or more and about 200 or less, for example.

### (2) Outer Electrodes

The outer electrodes 24 are adjacent to or in a vicinity of the first end surface 12e and the second end surface 12f of the ceramic body 12. The outer electrodes 24 include a first outer electrode 24a and a second outer electrode 24b.

The first outer electrode 24a is provided on a surface of the first end surface 12e of the ceramic body 12, and extends from the first end surface 12e to cover a portion of the first main surface 12a, a portion of the second main surface 12b, a portion of the first side surface 12c, and a portion of the second side surface 12d. In such a case, the first outer electrode 24a is electrically connected to the first extended electrode portions 20a of the first inner electrode layers 16a.

The second outer electrode 24b is provided on a surface of the second end surface 12f of the ceramic body 12, and extends from the second end surface 12f to cover a portion of the first main surface 12a, a portion of the second main surface 12b, a portion of the first side surface 12c, and a portion of the second side surface 12d. In such a case, the second outer electrode 24b is electrically connected to the second extended electrode portions 20b of the second inner electrode layers 16b.

An electrostatic capacitance is generated in the ceramic body 12 since the first opposing electrode portion 18a of the first inner electrode layer 16a and the second opposing electrode portion 18b of the second inner electrode layer 16b oppose each other with the ceramic layer 14 therebetween. Thus, an electrostatic capacitance is able to be provided between the first outer electrode 24a to which the first inner electrode layers 16a are connected and the second outer electrode 24b to which the second inner electrode layers 16b are connected, and the capacitor characteristics are exhibited.

The first outer electrode 24a and the second outer electrode 24b each include a base electrode layer 26 connected to the inner electrode layers 16, a conductive resin layer 28 on the base electrode layer 26, and a metal plating layer 30 on the conductive resin layer 28.

### (a) Base Electrode Layers

The base electrode layers 26 include a first base electrode layer 26a and a second base electrode layer 26b.

The first base electrode layer 26a is provided on a surface of the first end surface 12e of the ceramic body 12, and extends from the first end surface 12e to cover a portion of the first main surface 12a, a portion of the second main surface 12b, a portion of the first side surface 12c, and a portion of the second side surface 12d.

The second base electrode layer 26b is provided on a surface of the second end surface 12f of the ceramic body 12, and extends from the second end surface 12f to cover a portion of the first main surface 12a, a portion of the second main surface 12b, a portion of the first side surface 12c, and a portion of the second side surface 12d.

The thickness of the base electrode layer 26 that is on the first main surface 12a, the second main surface 12b, the first side surface 12c, and the second side surface 12d of the ceramic body 12 generally tends to be smaller than the thickness of the base electrode layer 26 that is on the first end surface 12e and the second end surface 12f, and is preferably about 5 μm or more and about 20 μm or less, for example.

Alternatively, the base electrode layer 26 may be omitted, and the outer electrodes 24 may be defined only by the plating layers. In the description below, a structure of a plating layer provided without a base electrode layer is described.

The first outer electrode 24a and the second outer electrode 24b may each be defined by directly providing a plating layer on a surface of the ceramic body 12 without providing a base electrode layer. In other words, the multilayer ceramic capacitor may have a structure including plating layers electrically connected to the first inner electrode layers 16a and the second inner electrode layers 16b. In such a case, plating layers may be formed after a pretreatment of placing a catalyst on surfaces of the ceramic body 12.

The plating layers preferably each include, for example, a lower layer plating electrode provided on a surface of the ceramic body 12, and an upper layer plating electrode provided on the surface of the lower layer plating electrode.

The lower layer plating electrode and the upper layer plating electrode each preferably include at least one metal selected from Cu, Ni, Sn, Pb, Au, Ag, Pd, Bi, Zn, etc., or an alloy including any of these metals, for example.

The lower layer plating electrode is preferably made of, for example, Ni, which has solder barrier performance, and the upper layer plating electrode is preferably made of, for example, Sn or Au, which has excellent solder wettability. Furthermore, for example, when the first inner electrode layers 16a and the second inner electrode layers 16b are made of Ni, the lower layer plating electrode is preferably made of, for example, by Cu, which has good bondability to Ni. The upper layer plating electrode may be provided if desired, and the first outer electrode 24a and the second outer electrode 24b may each be defined by only a lower layer plating electrode.

The plating layer may include the upper layer plating electrode as the outermost layer, or another plating electrode may be provided on the upper layer plating electrode.

The thickness of one layer of the plating layer provided without providing a base electrode layer is preferably about 1 μm or more and about 15 μm or less, for example. The plating layers are preferably free of glass. The metal ratio of the plating layers per unit volume is preferably about 99 vol % or more, for example.

### (b) Conductive Resin Layers

The conductive resin layers 28 include a first conductive resin layer 28a and a second conductive resin layer 28b.

The first conductive resin layer 28a is provided on the first base electrode layer 26a. Specifically, the first conductive resin layer 28a is provided on the first base electrode layer 26a that is on the first end surface 12e, and on the first base electrode layer 26a that is on the first main surface 12a, the second main surface 12b, the first side surface 12c, and the second side surface 12d.

Similarly, the second conductive resin layer 28b is provided on the second base electrode layer 26b. Specifically, the second conductive resin layer 28b is provided on the second base electrode layer 26b that is on the second end surface 12f, and on the second base electrode layer 26b that is on the first main surface 12a, the second main surface 12b, the first side surface 12c, and the second side surface 12d.

The thickness of the conductive resin layer 28 is, for example, preferably about 10 μm or more and about 200 μm or less.

The conductive resin layer 28 includes a thermosetting resin and metal powder (conductive filler). Since the conductive resin layer 28 includes a thermosetting resin, for example, the conductive resin layer 28 has higher flexibility than the base electrode layer 26 and the metal plating layer 30. Thus, even when physical impact or impact caused by thermal cycles is applied to the multilayer ceramic capacitor 10, the conductive resin layer 28 defines and functions as a buffer layer, and the multilayer ceramic capacitor 10 is able to be prevented from cracking.

A resin included in the conductive resin layer 28 is preferably a thermosetting resin, for example. Specific examples of the thermosetting resin include various known thermosetting resins, for example, epoxy resins, phenolic resins, urethane resins, silicone resins, and polyimide resins. Among these, epoxy resins have excellent heat resistance, moisture resistance, and adhesion, and are one of the most suitable resins. The conductive resin layer 28 preferably includes a curing agent in addition to the thermosetting resin, for example. When an epoxy resin is included as a base resin, examples of the curing agent that may be used include various known compounds based on phenol, amine, acid anhydrides, and imidazole.

Ag powder, Cu powder, or an alloy powder of these may be included as the metal powder included in the conductive resin layer 28. Moreover, metal particles with Ag-coated surfaces may also be used. When metal particles with Ag-coated surfaces are used, Cu or Ni is preferably included in the metal particles, for example. Alternatively, Cu subjected to an antioxidizing treatment may be used. The Ag-coated metal particles are included to reduce the cost for the metal particles included as the base material while maintaining the properties of Ag.

The shape of the metal powder (conductive filler) included in the conductive resin layer 28 is not particularly limited. The metal powder may be spherical metal powder or flat metal powder but is preferably a mixture of spherical metal powder and flat metal powder, for example. The average particle size of the metal powder may preferably be, for example, about 0.3 μm or more and about 10.0 μm or less, but is not particularly limited. The metal powder mainly provides a current carrying property to the conductive resin layer 28. Specifically, a current carrying path is provided inside the conductive resin layer 28 due to the direct contact between particles of the metal powder and/or conduction mechanisms, for example, a tunneling effect, of the conductive bonding material. The tip of the conductive resin layer 28 preferably extends about 50 μm or more and about 800 μm or less from the tip of the base electrode layer 26, for example. Accordingly, a sufficient area is able to be provided for the conductive resin layer 28 to decrease the stress during the heat impact cycles, and thus the solder cracking moderating effect is able to be provided.

Here, as shown in FIG. 4, the maximum thickness of the first conductive resin layer 28a in the first outer electrode 24a on the first end surface 12e of the ceramic body 12 is denoted as T1. The maximum thickness of the first conductive resin layer 28a in the stacking direction x from the first main surface 12a or the second main surface 12b of the ceramic body 12 is denoted as t1, and the maximum thickness of the first base electrode layer 26a in the stacking direction x from the first main surface 12a or the second main surface 12b of the ceramic body 12 is denoted as t2. The difference between the thickness t1 and the thickness t2 is denoted as maximum thickness T2 of the first conductive resin layer 28a adjacent to the first main surface 12a or the second main surface 12b of the ceramic body 12. Here, T1/T2 is about 2.4 or more and 16.0 or less. Preferably, T1/T2 is about 2.7 or more, for example.

Similarly, the maximum thickness of the second conductive resin layer 28b in the second outer electrode 24b on the second end surface 12f of the ceramic body 12 is denoted as T1. The maximum thickness of the second conductive resin layer 28b in the stacking direction x from the first main surface 12a or the second main surface 12b of the ceramic body 12 is denoted as t1, and the maximum thickness of the second base electrode layer 26b in the stacking direction x from the first main surface 12a or the second main surface 12b of the ceramic body 12 is denoted as t2. The difference between the thickness t1 and the thickness t2 is denoted as a maximum thickness T2 of the second conductive resin layer 28b adjacent to the first main surface 12a or the second main surface 12b of the ceramic body 12. Here, T1/T2 is about 2.4 or more and 16.0 or less. Preferably, T1/T2 is about 2.7 or more, for example.

Alternatively, the maximum thickness of the first conductive resin layer 28a in the first outer electrode 24a on the first end surface 12e of the ceramic body 12 is denoted as T1. The maximum thickness of the first conductive resin layer 28a in the width direction y from the first side surface 12c or the second side surface 12d of the ceramic body 12 is denoted as t1, and the maximum thickness of the first base electrode layer 26a in the width direction y from the first side surface 12c or the second side surface 12d of the ceramic body 12 is denoted as t2. The difference between the thickness t1 and the thickness t2 is denoted as a maximum thickness T2 of the first conductive resin layer 28a adjacent to the first side surface 12c or the second side surface 12d of the ceramic body 12. Here, T1/T2 is about 2.4 or more and 16.0 or less. Preferably, T1/T2 is about 2.7 or more, for example.

Similarly, the maximum thickness of the second conductive resin layer 24b in the second outer electrode 24b that lies on the second end surface 12f of the ceramic body 12 is denoted T1. The maximum thickness of the second conductive resin layer 28b in the width direction y from the first side surface 12c or the second side surface 12d of the ceramic body 12 is denoted as t1, and the maximum thickness of the second base electrode layer 26b in the width direction y from the first side surface 12c or the second side surface 12d of the ceramic body 12 is denoted as t2. The difference between the thickness t1 and the thickness t2 is denoted as a maximum thickness T2 of the second conductive resin layer 28b adjacent to the first side surface 12c or the second side surface 12d of the ceramic body 12. Here, T1/T2 is about 2.4 or more and 16.0 or less. Preferably, T1/T2 is about 2.7 or more, for example.

For example, the cross section of the multilayer ceramic capacitor 10 observed as such is a section provided by cutting the multilayer ceramic capacitor 10 in the length direction z and the stacking direction x. This section is provided by immobilizing the multilayer ceramic capacitor 10 in a resin, and exposing the section by polishing the portion that includes the first inner electrode layers 16a, the second inner electrode layers 16b, the first outer electrode 24a and the second outer electrode 24b up to a center portion in the width direction y of the multilayer ceramic capacitor 10. To avoid polishing sag and the like, the section is surface-treated, and the section of the first outer electrode 24a and the second outer electrode 24b is observed with a SEM at a magnification of 1000x, for example.

### (c) Metal Plating Layers

The metal plating layers 30 include a first metal plating layer 30a and the second metal plating layer 30b.

The first metal plating layer 30a is provided on the first conductive resin layer 28a. Specifically, the first metal plating layer 30a is provided on the first conductive resin layer 28a on the first end surface 12e, and on the first conductive resin layer 28a on the first main surface 12a, the second main surface 12b, the first side surface 12c, and the second side surface 12d.

The second metal plating layer 30b is provided on the second conductive resin layer 28b. Specifically, the second metal plating layer 30b is provided on the second conductive resin layer 28b on the second end surface 12f, and on the second conductive resin layer 28b on the first main surface 12a, the second main surface 12b, the first side surface 12c, and the second side surface 12d.

Examples of the material for the first metal plating layer 30a and the second metal plating layer 30b include at least one metal selected from Cu, Ni, Sn, Ag, Pd, Ag—Pd alloys, Au, etc., or an alloy including any of these metals. Preferably, the first metal plating layer 30a has a two-layer structure including a first Ni plating layer 32a and a first Sn plating layer 34a, for example. The second metal plating layer 30b preferably has a two-layer structure including a second Ni plating layer 32b and a second Sn plating layer 34b, for example. The Ni plating layers 32 are able to prevent solder leaching on the base electrode layer 26 by the solder that mounts the multilayer ceramic capacitor 10. The Sn plating layers 34 significantly improve wettability to the solder that mounts the multilayer ceramic capacitor 10 and facilitates mounting of the multilayer ceramic capacitor 10. The thickness of one plating layer is preferably about 1 μm or more and about 15 μm or less, for example.

The dimension of the multilayer ceramic capacitor 10, which includes the ceramic body 12, the first outer electrode 24a, and the second outer electrode 24b, in the length direction z is denoted as the L dimension. The dimension of the multilayer ceramic capacitor 10, which includes the ceramic body 12, the first outer electrode 24a, and the second outer electrode 24b, in the stacking direction x is denoted as the T dimension. The dimension of the multilayer ceramic capacitor 10, which includes the ceramic body 12, the first outer electrode 24a, and the second outer electrode 24b, in the width direction y is denoted as the W dimension.

The size of the multilayer ceramic capacitor 10 is not particularly limited; for example, preferably, the L dimension in the length direction z is about 1.0 mm or more and about 3.2 mm or less, the W dimension in the width direction y is about 0.5 mm or more and about 2.5 mm or less, and the T dimension in the stacking direction x is about 0.5 mm or more and about 2.5 mm or less.

According to this multilayer ceramic capacitor 10, the first inner electrode layers 16a and the second inner electrode layers 16b are stacked in a direction that connects the first main surface 12a and the second main surface 12b of the ceramic body 12.

In the multilayer ceramic capacitor 10 shown in FIG. 1, when the maximum thickness of the first conductive resin layer 28a in the first outer electrode 24a that lies on the first end surface 12e of the ceramic body 12 is denoted as T1 and the maximum thickness of the first conductive resin layer 28a adjacent to the first main surface 12a or the second main surface 12b of the ceramic body 12 is denoted as T2, and when the maximum thickness of the second conductive resin layer 28b in the second outer electrode 24b that lies on the second end surface 12f of the ceramic body 12 is denoted as T1 and the maximum thickness of the first conductive resin layer 28a adjacent to the first main surface 12a or the second main surface 12b of the ceramic body 12 is denoted as T2, increasing the thickness T1 increases the contraction stress acting toward the two end surfaces of the ceramic body 12 and increases the contact area between the particles of the metal filler included in the first conductive resin layers 28a and the second conductive resin layers 28b, resulting in a lower ESR. However, when the thickness T2 is excessively large, the contraction stress in the length direction z of the ceramic body 12 becomes excessively strong; thus, separation easily occurs at the contact portion (adjacent to or in a vicinity of an e dimension end portion 36) between the first conductive resin layer 28a and the ceramic body 12 and the contact portion (adjacent to or in a vicinity of the e dimension end portion 36) between the second conductive resin layer 28b and the ceramic body 12.

According to this multilayer ceramic capacitor 10, since T1/T2 satisfies the condition of about 2.4 or more and 16.0 or less, the ESR in the first outer electrode 24a and the second outer electrode 24b is able to be significantly reduced to a low level, and the adhesive force between the first conductive resin layer 28a and the first base electrode layer 26a and the adhesive force between the second conductive resin layer 28b and the second base electrode layer 26b is able to be significantly increased.

According to this multilayer ceramic capacitor 10, when T1/T2 satisfies the condition of about 2.7 or more and 16.0 or less, the ESR is able to be further reduced to a lower level, and the adhesive force between the first conductive resin layer 28a and the first base electrode layer 26a and the adhesive force between the second conductive resin layer 28b and the second base electrode layer 26b is able to be further increased.

Furthermore, according to this multilayer ceramic capacitor 10, the first base electrode layer 26a including a sintered metal is provided between the first conductive resin layer 28a and the ceramic body 12 and the second base electrode layer 26b including a sintered metal is provided between the second conductive resin layer 28b and the ceramic body 12; thus, the adhesion between the ceramic body 12 and the first base electrode layer 26a and between the ceramic body 12 and the second base electrode layer 26b, the adhesion between the first base electrode layer 26a and the first conductive resin layer 28a, and the adhesion between the second base electrode layer 26b and the second conductive resin layer 28b are excellent. Thus, the reliability of the multilayer ceramic capacitor 10 is able to be significantly improved.

Moreover, according to the multilayer ceramic capacitor 10, since the metal particles in the first conductive resin layer 28a and the second conductive resin layer 28b include Cu or Ag, excellent electrical conductivity is ensured in the first conductive resin layer 28a and the second conductive resin layer 28b.

In addition, according to the multilayer ceramic capacitor 10, since the first base electrode layer 26a and the second base electrode layer 26b include Cu, excellent electrical conductivity is ensured in the first base electrode layer 26a and the second base electrode layer 26b.

Furthermore, according to the multilayer ceramic capacitor 10, since the metal plating layer 30 includes the Ni plating layer 32, the moisture on the inner side of the metal plating layer 30 is able to be confined by the Ni plating layer 32, and solder popping, that is, popping-out of the solder and the moisture on the inner side of the metal plating layer 30, that occurs during mounting by reflowing, for example, is prevented.

### 2. Method for Producing Multilayer Ceramic Capacitor

Next, one example of a method for producing the aforementioned multilayer ceramic capacitor 10 is described.

First, ceramic green sheets that include a ceramic material that forms a ceramic body 12 (ceramic layers 14) are prepared.

Next, a conductive paste is applied to some of the ceramic green sheets to form conductive patterns. The conductive paste may be applied by, for example, various printing methods, such as a screen printing method. The conductive paste may include a known binder and a known solvent in addition to conductive fine particles.

Next, ceramic green sheets with no conductive patterns, ceramic green sheets with conductive patterns having shapes corresponding to the first and second inner electrode layers, and ceramic green sheets with no conductive patterns are stacked in that order, and pressed in the stacking direction to prepare a mother multilayer body.

Next, the mother multilayer body is cut along imaginary cutting lines on the mother multilayer body to prepare green ceramic multilayer bodies from the mother multilayer body. The mother multilayer body may be cut with a dicing machine or by press cutting. The green ceramic multilayer bodies may be subjected to barrel polishing or the like to round the ridge portions and corner portions.

Next, the green ceramic multilayer bodies are fired. In this firing step, the first and second inner electrode layers are fired. The firing temperature may be appropriately set according to the type of the ceramic material and conductive paste that are included. The firing temperature may preferably be, for example, about 900° C. or more and about 1300° C. or less.

Next, a conductive paste is applied to two end portions of the fired ceramic multilayer body (ceramic body) by, for example, a method such as dipping.

Then, the conductive paste applied to the ceramic multilayer body is dried under hot air for 10 minutes at about 60° C. or more and about 180° C. or less, for example.

Subsequently, the dried conductive paste is baked to form base electrode layers.

Alternatively, the base electrode layers may be plating layers formed by a plating process.

In other words, the first end surface 12e and the second end surface 12f of the ceramic body 12 are subjected to a plating process to form base plating electrodes on the exposed portions of the inner electrode layers 16a and 16b. When conducting the plating process, electrolytic plating or electroless plating may be used. However, electroless plating has a drawback in that a pretreatment that uses a catalyst is needed to improve the plating precipitation rate, which makes the process more complicated. Thus, in general, electrolytic plating is preferably used, for example. The plating technique is preferably a barrel plating technique, for example. If desired, upper layer plating electrodes may be formed on the surfaces of the lower layer plating electrodes by the same process or a similar process.

Next, a mixture of a thermosetting resin and a Cu or Ag metal filler that will define the metal particles in the conductive resin layers is applied to the surfaces of the base electrode layers and cured under heating to form conductive resin layers.

Here, the conductive resin layers are formed on the surfaces of the base electrode layers by applying a conductive resin paste. The specific process is as follows.

First, as shown in FIGS. 5A and 5B, a ceramic multilayer body 12′ with base electrode layers formed thereon is held by a tacky layer 42 provided on one main surface of a holder 40. The ceramic multilayer body 12′ is dipped in a conductive resin paste 46 filling a paste vessel 44 to form a conductive resin layer on the base electrode layer. The thickness T1 and the thickness T2 of the conductive resin layers may be adjusted by the pulling speed of the ceramic multilayer body 12′ having the base electrode layers formed thereon.

That is, as shown in FIG. 5A, when the ceramic multilayer body 12′ having the base electrode layers formed thereon is pulled up rapidly (pulling speed V1), a thick layer of the conductive resin paste 46 remains on the two main surfaces and two side surfaces of the ceramic multilayer body 12′, and a thin layer of the conductive resin paste 46 remains on the end surfaces.

Meanwhile, as shown in FIG. 5B, when the ceramic multilayer body 12′ having the base electrode layers formed thereon is pulled up slowly (pulling speed V2), i.e., when V1>V2, the conductive resin paste 46 flows downward from the two main surfaces and two side surfaces of the ceramic multilayer body 12′ toward the end surface; thus, a thin layer of the conductive resin paste 46 remains on the two main surfaces and two side surfaces of the ceramic multilayer body 12′, and a thick layer of the conductive resin paste 46 remains on the end surface.

When the depth (casting thickness) C of the conductive resin paste 46 filling the paste vessel 44 is relatively large, the thickness T1 may be adjusted to increase.

Subsequently, plating layers (Ni plating layers and Sn plating layers) are formed by electrolytic plating on the conductive resin layers to prepare a multilayer ceramic capacitor 10.

### 3. Experimental Examples

In order to confirm the advantageous effects of the multilayer ceramic capacitor of the present preferred embodiment of the present invention, samples with varying T1/T2 were prepared, and the ESR of each sample was measured.

Each sample was produced as follows.

(1) First, a ceramic body including inner electrode layers was prepared. The ceramic body was prepared by, for example, stacking and pressure-bonding ceramic green sheets with inner electrode patterns printed thereon to provide a multilayer body, and debinding and firing the multilayer body under particular conditions.

In this experimental example, the following ceramic body satisfying the conditions below was prepared as the ceramic body.
(a) Dimensions: about 1.6 mm in length, about 0.8 mm in width, and about 0.8 mm in thickness
(b) Rated voltage: 50 V
(c) Electrostatic capacity: about 0.1 μF

(2) Next, a conductive paste (Cu electrode paste) prepared by kneading a mixture of a Cu powder defining a conductive component, a binder, and other appropriate components was applied to end surfaces of the ceramic body and baked to form base electrode layers.

(3) Next, the following conductive resin paste was dip-coated on the base electrode layers and cured under the conditions of about 180° C. or more and about 230° C. or less for 10 min or more and 60 min or less to form conductive resin layers.

As indicated in the Table below, for the multilayer ceramic capacitors samples of the respective sample numbers, the speed at which the ceramic multilayer body was pulled up from the paste vessel was adjusted to change the thickness T1 and thickness T2 of the conductive resin layers in the outer electrodes.

Here, the conductive resin paste was prepared by kneading the mixture of the following components:
(a) Epoxy resin: bisphenol A epoxy resin, about 10 mass %
(b) Phenolic curing agent: novolac phenolic resin, about 1 mass %
(c) Conductive component (Ag-coated Cu powder+Ag powder): about 69 mass %
(d) Curing accelerator (imidazole compound): appropriate amount
(e) Coupling agent (silane coupling agent): appropriate amount
(f) Solvent: Diethylene glycol monobutyl ether, the balance

The conductive component was a mixture of the following Ag-coated Cu powder and Ag powder.

### Ag-Coated Cu Powder

An Ag-coated Cu powder that had a spherical shape and had an average particle diameter D50 of about 3 μm or more and about 4 μm or less and an Ag ratio of about 20.9 mass % relative to the total amount of Ag and Cu was used.

### Ag Powder

An Ag powder that had a flake shape and had an average particle diameter D50 of about 2.6 μm was used.

(4) The ceramic body on which the base electrode layers and the conductive resin layers were formed as described above was subjected to Ni plating and Sn plating to form metal plating layers having Ni plating layers and Sn plating layers on the surfaces of the conductive resin layers. As a result, multilayer ceramic capacitors (multilayer ceramic electronic components) of Sample Nos. 1 to 6 indicated in the Table having the structure shown in FIG. 1 were obtained.

The asterisked sample number (sample No. 5) in the Table is a sample that does not satisfy the requirements of the present invention.

### (5) Evaluation of Characteristics

The equivalent series resistance (ESR) of each of the multilayer ceramic capacitors of Sample Nos. 1 to 6 indicated in the Table in which the outer electrodes were formed as described above was measured.

The ESR was measured by mounting each sample onto a measurement substrate and then measuring the ESR with a network analyzer (E5071C) at a measurement voltage of about 500 mV and a measurement frequency of about 10 MHz.

Note that the dimensions of the thickness T1 and the thickness T2 are the average value of five specimens of each sample number, and are the dimensions of one of the outer electrodes. Here, the thickness T1 was a maximum thickness of the first conductive resin layer in the first outer electrode that lies on first end surface of the ceramic body, and the thickness T2 was the maximum thickness of the first conductive resin layer adjacent to the second main surface of the ceramic body.

The number of specimens on which the ESR was measured was 20 for each sample number.

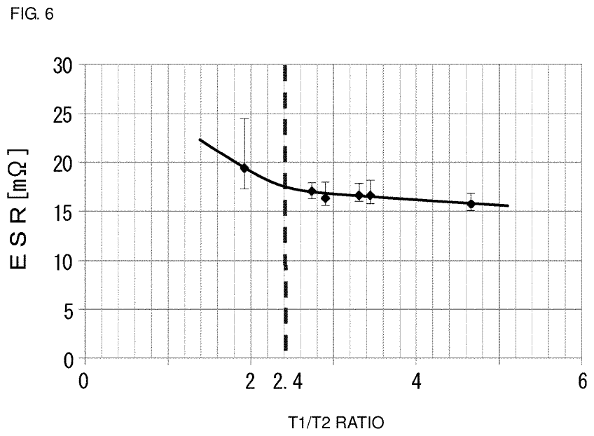

The Table indicates the measurement results of the dimensions of the thickness T1 and the thickness T2 of each sample number, and the measurement results of the ESR, and FIG. 6 indicates a graph in which the measurement results of the maximum ESR and the minimum ESR of each sample were plotted.

| | | | | TABLE | | |
|---|---|---|---|---|---|---|
| | | | | ESR (mΩ) | | |
| Sample | | | | | Maximum | Minimum |
| No. | T1 (μm) | T2 (μm) | T1/T2 | Average | value | value |
| 1 | 46.0 | 16.8 | 2.7 | 17.1 | 17.9 | 16.3 |
| 2 | 47.0 | 16.2 | 2.9 | 16.3 | 18.0 | 15.6 |
| 3 | 52.6 | 15.9 | 3.3 | 16.6 | 17.9 | 16.0 |
| 4 | 51.0 | 14.8 | 3.4 | 16.6 | 18.2 | 15.8 |
| *5 | 35.0 | 18.2 | 1.9 | 19.4 | 24.4 | 17.3 |
| 6 | 96.0 | 20.6 | 4.7 | 15.7 | 16.8 | 15.1 |

According to the Table and FIG. 6, in the samples of Nos. 1 and 4 to 6 having a T1/T2 of about 2.4 or more, the ESR was relatively low, and the variation in the measured ESR values was in a small range. Accordingly, it became clear that, compared to the sample of No. 5, the samples of Nos. 1 and 4 to 6 having a T1/T2 of about 2.4 or more could significantly reduce the ESR to a low level with less variation. It also became clear that when T1/T2 was about 2.7 or more, the ESR could be further reduced to a lower level. This is presumably because, since T1/T2 was about 2.7 or more, increasing the thickness T1 increased the contraction stress acting toward the two end surfaces of the ceramic body and increased the contact area between the particles of the metal filler included in the conductive resin layers, thereby decreasing the ESR.

In contrast, in the sample of No. 5, the ESR as the average value of twenty specimens was about 19.4 mΩ, the maximum value was about 24.4 mΩ, and the minimum value was about 17.3 mΩ. Thus, the variation in the measured ESR values was large. This is presumably because, since T1/T2 was less than about 2.4 and the thickness T1 was smaller than those of other samples, the contraction stress acting toward the two end surfaces of the ceramic body became weak, and the contact area between the particles of the metal filler included in the conductive resin layers decreased, thereby increasing the ESR and the variation of the ESR.

Although preferred embodiments of the present invention have been described above, the present invention is not limited to these preferred embodiments.

The aforementioned preferred embodiments are subject to various modifications regarding the mechanisms, shapes, materials, quantities, positions, arrangements, etc., without departing from the technical idea and scope of the present invention, and such modifications are to be included in the scope of the present invention.

For example, although the outer electrodes are provided on the side surfaces of the ceramic body in the preferred embodiments and examples described above, the outer electrodes need not be provided on the side surfaces of the ceramic body. It is sufficient if the outer electrodes are provided on the end surfaces of the ceramic body and at least the first main surface or the second main surface of the ceramic body. When the outer electrodes of the multilayer ceramic electronic component are provided as such, the multilayer ceramic electronic component is able to be easily mounted by including, as the mounting surface, the first or second main surface on which the outer electrode is formed.

Although the plating layer is defined by a Ni plating layer and a Sn plating layer in the preferred embodiments and examples described above, the plating layer may be defined by one plating layer or three or more plating layers.

Furthermore, although a dielectric ceramic was used as the material for the ceramic body in the preferred embodiments and the examples described above, in the present invention, a magnetic ceramic, for example, ferrite, a semiconductor ceramic, for example, a spinel ceramic, and a piezoelectric ceramic, for example, a PZT ceramic may be used as the material for the ceramic body depending on the type of the multilayer ceramic electronic component.

When a magnetic ceramic is included in the ceramic body, the multilayer ceramic electronic component defines and functions as a multilayer ceramic inductor. When a semiconductor ceramic is included in the ceramic body, the multilayer ceramic electronic component defines and functions as a multilayer ceramic thermistor. When a piezoelectric ceramic is included in the ceramic body, the multilayer ceramic electronic component defines and functions as a multilayer ceramic piezoelectric component. However, when the multilayer ceramic electronic component is to define and function as a multilayer ceramic inductor, the inner electrode layer is a coil-shaped conductor.

Although a multilayer ceramic capacitor having a particular structure is described as an example in the preferred embodiments and examples described above, the structure of the multilayer ceramic capacitor according to the present invention may be freely changed within the scope of the structure defined by the claims.

The multilayer ceramic electronic components according to preferred embodiments of the present invention is particularly suitable as, for example, a multilayer ceramic capacitor, a multilayer ceramic inductor, a multilayer ceramic thermistor, and a multilayer ceramic piezoelectric component.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a ceramic body including:
a plurality of ceramic layers that are stacked; and
a first inner electrode and a second inner electrode that are stacked;
the ceramic body including a first main surface and a second main surface that face each other in a stacking direction, a first side surface and a second side surface that face each other in a width direction orthogonal or substantially orthogonal to the stacking direction, and a first end surface and a second end surface that face each other in a length direction orthogonal or substantially orthogonal to the stacking direction and the width direction;
a first outer electrode on the first end surface of the ceramic body and electrically connected to the first inner electrode layer, the first outer electrode extending from the first end surface and cover a portion of the first main surface, a portion of the second main surface, a portion of the first side surface, and a portion of the second side surface; and
a second outer electrode on the second end surface of the ceramic body and electrically connected to the second inner electrode layer, the second outer electrode extending from the second end surface and cover a portion of the first main surface, a portion of the second main surface, a portion of the first side surface, and a portion of the second side surface; wherein
the first outer electrode includes a first conductive resin layer including a metal filler dispersed in a resin;
the second outer electrode includes a second conductive resin layer including a metal filler dispersed in a resin;
when a maximum thickness of the first conductive resin layer in the first outer electrode that lies on the first end surface of the ceramic body is denoted as T1 and a maximum thickness of the first conductive resin layer adjacent to the first and second main surfaces of the ceramic body or the first and second side surfaces of the ceramic body is denoted as T2, T1/T2 is about 2.4 or more; and
when a maximum thickness of the second conductive resin layer in the second outer electrode that lies on the second end surface of the ceramic body is denoted as T3 and a maximum thickness of the second conductive resin layer adjacent to the first and second main surfaces of the ceramic body or the first and second side surfaces of the ceramic body is denoted as T4, T3/T4 is about 2.4 or more.

2. The multilayer ceramic electronic component according to claim 1, wherein
T1/T2 is about 2.7 or more; and
T3/T4 is about 2.7 or more.

3. The multilayer ceramic electronic component according to claim 1, wherein
the first outer electrode further includes a first base electrode layer between the first conductive resin layer and the ceramic body, the first base electrode layer including a sintered metal; and
the second outer electrode further includes a second base electrode layer between the second conductive resin layer and the ceramic body, the second base electrode layer including a sintered metal.

4. The multilayer ceramic electronic component according to claim 1, wherein
the first outer electrode further includes a first plating layer on a surface of the first conductive resin layer, the first plating layer including a plating metal; and
the second outer electrode further includes a second plating layer on a surface of the second conductive resin layer, the second plating layer including a plating metal.

5. The multilayer ceramic electronic component according to claim 1, wherein a thickness of each of the first conductive resin layer and the second conductive resin layer is between about 10 μm and about 200 μm.

6. The multilayer ceramic electronic component according to claim 1, wherein each of the first conductive resin layer and the second conductive resin layer includes a thermosetting resin and a metal powder.

7. The multilayer ceramic electronic component according to claim 6, wherein
the thermosetting resin is an epoxy resin; and
each of the first conductive resin layer and the second conductive resin layer further includes a curing agent.

8. The multilayer ceramic electronic component according to claim 6, wherein the metal powder is an Ag powder or a Cu powder.

9. The multilayer ceramic electronic component according to claim 1, wherein
T1/T2 is less than about 16.0; and
T3/T4 is less than about 16.0.

10. The multilayer ceramic electronic component according to claim 4, wherein each of the first plating layer and the second plating layer includes a two-layer structure including a Ni plating layer and a Sn plating layer.
